(19) United States
(12) Patent Application Publication
(10) Pub. No.: US 2006/0116023 A1
(43) Pub. Date: Jun. 1, 2006

(54) Equipment rack data/power distribution

(76) Inventors: James S. Spitaels, Worcester, MA (US); Rodger B. Dowdell JR., Saunderstown, RI (US); Joseph P. Gleason, East Greenwich, RI (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/232,162

(22) Filed: Sep. 20, 2005

Related U.S. Application Data
(60) Provisional application No. 60/611,667, filed on Sep. 20, 2004.

(51) Int. Cl. H01R 13/60

(52) U.S. Cl. 439/532

(57) ABSTRACT

A network apparatus for use in an equipment rack configured to store equipment, in vertically displaced equipment positions, includes a housing configured to be mounted to the rack, wherein the housing extends vertically in the rack to vertically overlap with at least two equipment positions, at least one network service device configured to provide at least one of power, console port server (CPS) service, Ethernet service, and user control switching, and network service interfaces connected to the at least one network service device and disposed in substantially horizontal alignment with respective vertically displaced equipment positions of the equipment rack.

### CROSS REFERENCE TO RELATED APPLICATIONS

This application claims the benefit of U.S. Provisional Application No. 60/611,667 filed Sep. 20, 2004, the contents of which are incorporated here by reference.

### BACKGROUND

In a typical networking installation, an equipment rack houses several network devices, each in a horizontal orientation, stacked vertically. This configuration allows easy access to the front and rear of installed equipment, easy interchange of individual components, and efficient cooling. Each rack generally contains a few infrastructure devices (e.g., remote access devices and data flow control devices) and several network-service devices (e.g., servers and storage devices). The infrastructure devices are generally mounted horizontally and occupy space otherwise usable by network-service devices.

In addition to the network devices, many cables are used in a typical networking installation. To provide network management and/or flow control services, individual cables interconnect the infrastructure devices and the network-service devices. Additional cables may provide application specific services such as Ethernet, print capability, and/or links to external storage for the network devices. Along with power cables for each installed device, the numerous cables occupy a space between the rear of the installed equipment and the rear of the rack, or alternatively may be located in a space between the front of the installed equipment and the front of the rack, or combinations of front and rear, and/or between the sides of the equipment and the side of the rack.

Generally, network administrators choose one of two options to manage the cabling within a rack. Cables of varying length are used to reduce excess cabling or, cables of equal length are used and excess length is “hanked” (e.g., coiled or bunched) and tied off.

The two cabling options present a choice between advantages and disadvantages for network administrators. Purchasing many cables of varying length is typically more expensive and bothersome than purchasing many cables of a single length. Constructing many cables of varying length is a time intensive process that can be more expensive than buying pre-made cabling. Furthermore, variable-length cables require a larger inventory of parts than using a single-length cable. Using a set of equal-length cables, while usually cheaper than variable-length cables, occupies a greater volume of space in the rack and leads to hanking. Hanked cabling, in addition to restricting access to the networking devices and potentially degrading signal quality, can block the flow of air in the rack, thereby reducing the cooling efficiency of the rack. A reduction in cooling efficiency can lead to damage or destruction of the networking devices.

### SUMMARY

In general, in an aspect, the invention provides a network apparatus for use in an equipment rack configured to store equipment, in vertically displaced equipment positions, the apparatus including a housing configured to be mounted to the rack, wherein the housing extends vertically in the rack to vertically overlap with at least two equipment positions, at least one network service device configured to provide at least one of power, console port server (CPS) service, Ethernet service, and user control switching, and network service interfaces connected to the at least one network service device and disposed in substantially horizontal alignment with respective vertically displaced equipment positions of the equipment rack.

Embodiments of the invention may include one or more of the following features. At least two of the network service interfaces are connected to the same network service device have a first center-to-center spacing of substantially an integer multiple of a U. The interfaces are disposed in groups, wherein each of the groups contains at least one of the network service interfaces corresponding to each of the at least one network service device, the groups having a second center-to-center spacing of substantially a multiple of a rack-unit (U). A quantity of the groups is equal to a quantity of the respective equipment positions in the rack.

Also, embodiments of the invention may include one or more of the following features. The at least one network service device is an Ethernet switch. The at least one network service device is configured to provide power and CPS service. The at least one network service device is configured to provide power and Ethernet switching. The at least one network service device is configured to provide power and user control switching. The at least one network service device is configured to provide user control switching. The user control switching is configured to provide keyboard/video/mouse (KVM) switching.

Also, embodiments of the invention may include one or more of the following features. The housing is configured to toollessly mount to the rack. The housing further includes a protrusion configured to be inserted into and slide within a keyhole-shaped opening provided by the rack and to resist removal from the opening without sliding the protrusion within the opening. The network apparatus occupies substantially an entire width of a recess provided by the rack between the equipment and an end wall of the rack. The housing is sized to fit between a side wall of the rack and a side of the equipment disposed in the equipment positions without substantially blocking an air flow between the equipment and an end wall of the rack. The network apparatus occupies substantially half of an entire width of a recess provided by the rack between the equipment installed in the rack, and an end of the rack.

Also, embodiments of the invention may include one or more of the following features. The network apparatus further includes a primary and a secondary Ethernet printed circuit board, a primary Ethernet switch chip disposed on the primary Ethernet printed circuit board, a secondary Ethernet switch chip disposed on the secondary printed circuit board, an Ethernet connector connected to the secondary Ethernet switch chip, and a high-speed Ethernet connection between the primary Ethernet switch chip and the secondary Ethernet switch chip. The network apparatus further includes a primary CPS printed circuit board, a secondary CPS printed circuit board, a microcontroller, a universal asynchronous receiver-transmitter (UART), a bus connected to the microcontroller and to the UART, wherein the microcontroller, the bus, and the UART are disposed on the primary CPS printed circuit board, and a transceiver disposed on the secondary CPS printed circuit board, each of the transceivers being connected to the UART. The network apparatus further includes a primary KVM printed circuit board, a secondary KVM printed circuit board, an external interface and a primary KVM switch chip disposed on the primary KVM printed circuit board, and a secondary KVM switch chip disposed on the secondary KVM printed circuit board, wherein the secondary KVM switch chip is connected to the primary KVM switch chip. The network apparatus further includes a primary KVM printed circuit board, a secondary KVM printed circuit board, an external interface disposed on the primary KVM printed circuit board, and a KVM switch chip disposed on the secondary KVM printed circuit board, the KVM switch chip being connected to the external interface. The network apparatus further includes secondary KVM PCBs, each including a secondary KVM switch chip, wherein the secondary KVM switch chips are daisy-chain connected. The at least one external interface is connected to one end of the serial configuration of the KVM switch chips.

In general, in another aspect, the invention provides a Zero-U network apparatus for use in an equipment rack that provides a vertical recess, the apparatus including a housing configured to be mounted to the rack, an Ethernet switch disposed on a first set of printed circuit boards, a power distribution unit (PDU) disposed on a second set of printed circuit boards, and multiple connector groups each including at least one Ethernet connector and at least one power receptacle, the at least one Ethernet connector being connected to the Ethernet switch, the at least one power receptacle being connected to the PDU.

Embodiments of the invention may include one or more of the following features. The Zero-U network apparatus further includes a console port server module disposed on a third set of printed circuit boards, and multiple console port server connectors connected to the console port server module, each of the connector groups further including at least one of the console port server connectors. The Zero-U network apparatus further includes a keyboard/video/mouse (KVM) switch, and KVM interfaces connected to the KVM switch, each of the connector groups further including at least one of the KVM interfaces. The groups are disposed over a height greater than 24 inches. The groups are disposed with a center-to-center spacing of about an integer multiple of a rack unit (U) apart. The connector groups are substantially horizontally aligned with an equipment position in the equipment rack. Each of the at least one Ethernet connector is substantially horizontally aligned with a corresponding Ethernet connection on a piece of equipment installed in the rack. Each of the at least one power receptacle is substantially horizontally aligned with a corresponding power connection on a piece of equipment installed in the rack.

Also, embodiments of the invention may include one or more of the following features. Each of the plurality of groups is substantially horizontally aligned with a corresponding rack position. The Zero-U network apparatus further includes at least one of a console port server device, a user control switching device, an environmental monitoring device, and physical status monitoring device. The Zero-U network apparatus extends substantially an entire internal height of the equipment rack. The Zero-U network apparatus further includes protrusions disposed on a back of the housing, the protrusions adapted to be slidably received by openings provided by the equipment rack, wherein the protrusions are configured to resist removal of the Zero-U network apparatus from the rack without sliding the protrusions within the openings, whereby the protrusions allow toolless mounting of the zero-U network apparatus in the equipment rack. The protrusions are T-shaped. The Zero-U network apparatus further includes an adapter configured to be mounted to the rack, and protrusions disposed on a back of the housing, the protrusions adapted to be slidably received by a plurality of openings provided by at least one adapter bracket, the adapter bracket being disposed on a support beam of the equipment rack, wherein the protrusions are configured to resist removal of the Zero-U network apparatus from the adapter bracket without sliding the protrusions within the openings, whereby the protrusions allow toolless mounting of the zero-U network apparatus to the adapter in the equipment rack.

In general, in another aspect, the invention provides a network apparatus including an equipment rack having vertically displaced equipment positions, a housing configured to be mounted in the equipment rack, wherein the housing extends vertically in the rack to vertically overlap with at least two of the equipment positions, at least one network service device configured to provide at least one of power, console port server (CPS) service, Ethernet service, and user control switching, and network service interfaces connected to the at least one network service device and disposed in substantially horizontal alignment with respective vertically displaced equipment positions of the equipment positions of the equipment rack.

Embodiments of the invention may include one or more of the following features. The interfaces are disposed in groups, wherein each of the groups contains at least one of the network service interfaces corresponding to each of the at least one network service device, the groups having a second center-to-center spacing of substantially a multiple of a rack-unit (U). Each of the groups is substantially horizontally aligned with one of the horizontal equipment positions. The housing is configured to toollessly mount to the rack. The housing provides a vertically-extending recess and the housing is configured to be disposed in the recess without substantially horizontally overlapping with equipment disposed in the equipment positions.

Various aspects of the invention may provide one or more of the following capabilities. Cable clutter in a rack of equipment may be reduced, and possibly minimized, compared to current techniques. Air flow in a rack of equipment may be improved compared to current techniques. Ethernet, console port access, and/or keyboard/video/mouse signals, and possibly power signals, may be provided in a rack of equipment without using a horizontal equipment position otherwise usable for rack-mounted equipment. Available rack space may be increased and/or maximized for server use. Server management user interfaces and/or access control lists may be consolidated. A quantity of IP addresses dedicated to server management may be reduced, e.g., to one per rack. Installation of server management hardware may be simplified. Server management installation may be accomplished toollessly. Server management hardware may be installed in a rack without using server-usable space. The cost and/or the amount of spare parts for server management equipment may be reduced. A single user interface may be provided for multiple (e.g., four) server management functions. A single user access list may be provided for several, e.g., four, management functions. A shorter average cable length may be used increasing the signal integrity.

These and other capabilities of the invention, along with the invention itself, will be more fully understood after a review of the following figures, detailed description, and claims.

### BRIEF DESCRIPTION OF THE FIGURES

FIG. 1 is a simplified diagram of a network system including a management unit connected to multiple network devices.

FIG. 2 is an exemplary diagram of a network installation including a rack, the network devices, and the management unit shown in FIG. 1.

FIG. 3 is an exemplary block diagram of a network switch.

FIG. 4 is an exemplary block diagram of a console port server module.

FIG. 5 is an exemplary block diagram of a keyboard/video/mouse (KVM) module using several printed circuit boards (PCBs) and a switch in a hierarchical arrangement.

FIG. 6 is an exemplary block diagram of a KVM module using several PCBs and multiple daisy-chained KVM switches.

FIG. 7 is an exemplary diagram of a network installation including a rack, network devices, and a half-width management unit.

FIG. 8 is a side view of the management unit shown in FIG. 7.

FIG. 9 is a plan view of the network installation, including a rack, taken from above the rack, with a top cover of the rack removed for clarity.

FIG. 10 is another exemplary block diagram of a network switch.

### DETAILED DESCRIPTION OF PREFERRED EMBODIMENTS

Embodiments of the invention provide a vertically oriented, “Zero-U” apparatus for providing services such as network services, power, console port access, keyboard/video/mouse access, etc. to devices installed in an equipment rack. For example, Zero-U Ethernet switches, console port servers, and/or keyboard/video/mouse switches are provided. One or more network infrastructure devices are packaged in a vertical configuration designed to be installed in an available space between a rack vent (e.g., at the rear of the rack) the equipment (e.g., the rear of the equipment) installed within the rack. Preferably, the installation is accomplished without substantially impeding access to the equipment or substantially blocking air flow from the equipment out of the rack. The apparatus preferably spans the entire height of the rack, at least parallel to equipment positions in the rack, and provides each rack position with an interface corresponding to each service provided. For example, a 42 U high combination power and keyboard/video/mouse (“KVM”) switch preferably contains 42 power outlets and 42 KVM interfaces, with each outlet and interface substantially horizontally aligned with a corresponding U of rack space (i.e., each position that can hold a piece of equipment). Preferably, short cables horizontally connect each outlet and interface with a corresponding network device. Other embodiments are within the scope of the disclosure.

Various aspects of the invention may provide one or more of the following features. The apparatus may toollessly mount in vertical channels at the rear of an equipment rack (e.g., a NetShelter® VX or SX cabinet manufactured by American Power Conversion (APC) Corporation of West Kingston, R.I.). In a full-width configuration (e.g., where the apparatus occupies an entire width of a space in the rack dedicated to the apparatus), the apparatus preferably contains an Ethernet switch, a console port server, and a power distribution unit, or an Ethernet switch, a KVM switch, and a power distribution unit. A full-width device could also include an Ethernet switch, a console port server, a KVM switch, and a power distribution unit. Single-function half- or full-width devices could also be provided.

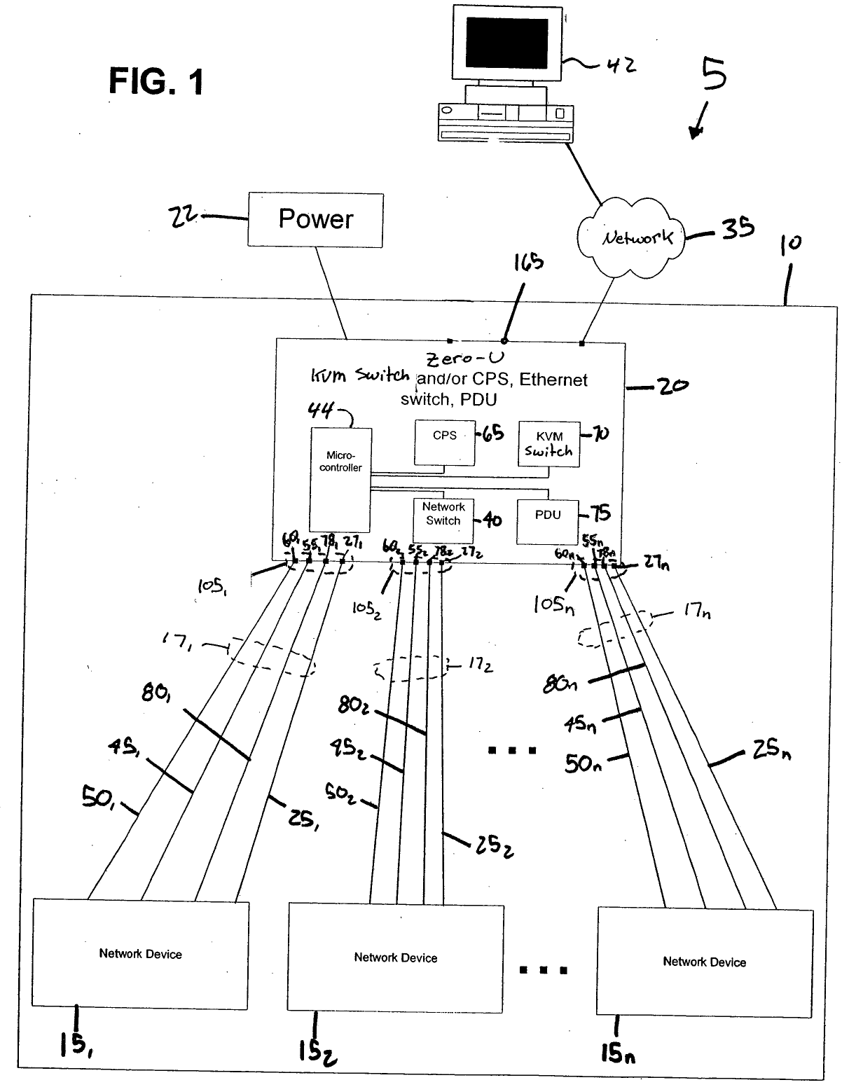

Referring to FIG. 1, a networking system 5 includes a rack system 10, a power source 22, a data network 35, and an access device 42. The power source 22 is configured to provide power to the rack system 10 (e.g., 208V/20 A, three-phase service, which is then stepped-down to a lower voltage such as 120V, single-phase). The rack system 10 is connected to the data network 35, (e.g., a LAN, WAN, or Intranet) for bi-directional communication. The rack system 10 is further connected for bi-directional communication to the access device 42 via the data network 35. The access device 42 is a computing device such as a personal computer. While one rack system 10, one power source 22, and one access device 42 are shown, other quantities of racks, power sources, and/or access devices may be used. The system 5 shown is an exemplary system and not limiting of the invention.

The rack system 10 includes multiple network devices 15 and a management unit 20. The management unit 20 provides Ethernet switching, console port access, KVM signaling, and/or power to the network devices 15, or any combination therein (including single-function devices). While here the management unit 20 provides both console port access via a console port server (CPS) and KVM signaling, at least some other embodiments of management units may provide either CPS or KVM functionality. Generally, a CPS connection provides an interface allowing a network administrator to remotely access Linux®-based versions of the network devices 15. CPS may, however, be used with non-Linux®-based versions of the network devices 15 using other operating systems such as Windows Server® 2003. Generally, a KVM connection provides an interface allowing a network administrator to remotely access Windows®-based versions of the network devices 15. KVM may, however, be used with non-Windows®-based versions of the network devices 15 using other operating systems such as Linux devices. A KVM connection and/or CPS connection that interfaces with both Linux-based and Windows®-based versions of the network devices 15 is possible. Furthermore, the KVM signaling may be SUN® and/or USB compatible.

The management unit 20 includes a CPS module 65, a KVM switch 70, a network switch 40 (here an Ethernet switch), and a power distribution unit (“PDU”) 75. The CPS module 65, the KVM switch 70, the network switch 40, and the PDU 75 are each connected to individual network devices 15 through a corresponding set 105 of ports and a corresponding set of cables 17. The network switch 40 is connected to the network devices 15₁-15ₙ through the RJ-45 connector 27₁-27ₙ over Ethernet cables 25₁-25ₙ that are Category-5 cables, although other cables and connectors may be used (e.g., Cat-5e, Cat-6, Cat-6 Augmented, etc.). The CPS module 65 is connected to the network devices 15₁-15ₙ through DB9 or RJ-45 connectors 55₁-55ₙ over CPS cables 45₁-45ₙ, that are Category-5 cables, although other cables and connectors may be used, and/or other connections such as wireless connections (e.g., Wi-Fi, Bluetooth, wireless USB). Furthermore, a single cable may be used wherein the end of the cable that connects to the management unit 20 has a single high-density connector (i.e., a single connector that provides KVM, CPS, and Ethernet) and the other end of the cable has a connector corresponding to each service provided (e.g., separate Ethernet, CPS, and KVM cables to connect to the network devices 15). The KVM switch 70 is connected to the network devices 15₁-15ₙ through KVM connectors 60₁-60ₙ, over KVM cables 50₁-50ₙ that are Category-5 cables, although other cables and connectors may be used (e.g., traditional VGA+PS/2 connectors with shielded cables/connectors, DVI, and USB). The PDU 75 is connected to the network devices 15₁-15ₙ, through IEC-60320-C13 receptacles 78₁-78ₙ, over power cables 80₁-80ₙ that are standard power cables, although other receptacles and cables may be used (e.g., NEMA 5-15, 5-20, and IEC 60320-C19). While the network switch 40 is shown as an Ethernet switch, other protocols may be used (e.g., Infiniband, Fibre Channel, SONET, Myrinet, etc.) The management unit 20 contains a controller 44 that is used to access and control the infrastructure services provided by the management unit 20. The controller 44 is, e.g., a Motorola PowerPC MPC875ZT133. The controller 44 is connected to communicate with the network switch 40, the CPS module 65, the KVM switch 70, the PDU 75, and an optional memory (not shown). The controller 44 may also be connected to the access device 42. The controller 44 provides an interface for the network administrator to control and monitor the management unit 20 and the network devices 15. The controller 44 may be externally accessible to the network administrator via the data network 35, the CPS module 65, and/or the KVM switch 70. For example, the network administrator could access the management unit 20 using a Web page via a single Internet-protocol (IP) address assigned to the controller 44, thus creating a central access point to devices connected to the management unit 20 and services provided by the controller 44.

The connections in the management unit 20 shown in FIG. 1 are exemplary only. For example, while FIG. 1 shows the CPS module 65, the KVM switch 70, the network switch 40, and the PDU 75 all directly connected to the controller 44, other connections may be used (e.g., the CPS module 65 may be connected to the network switch 40, or directly to the access device 42). Additionally, any of the connections shown within the management unit 20 may be accomplished through the network switch 40.

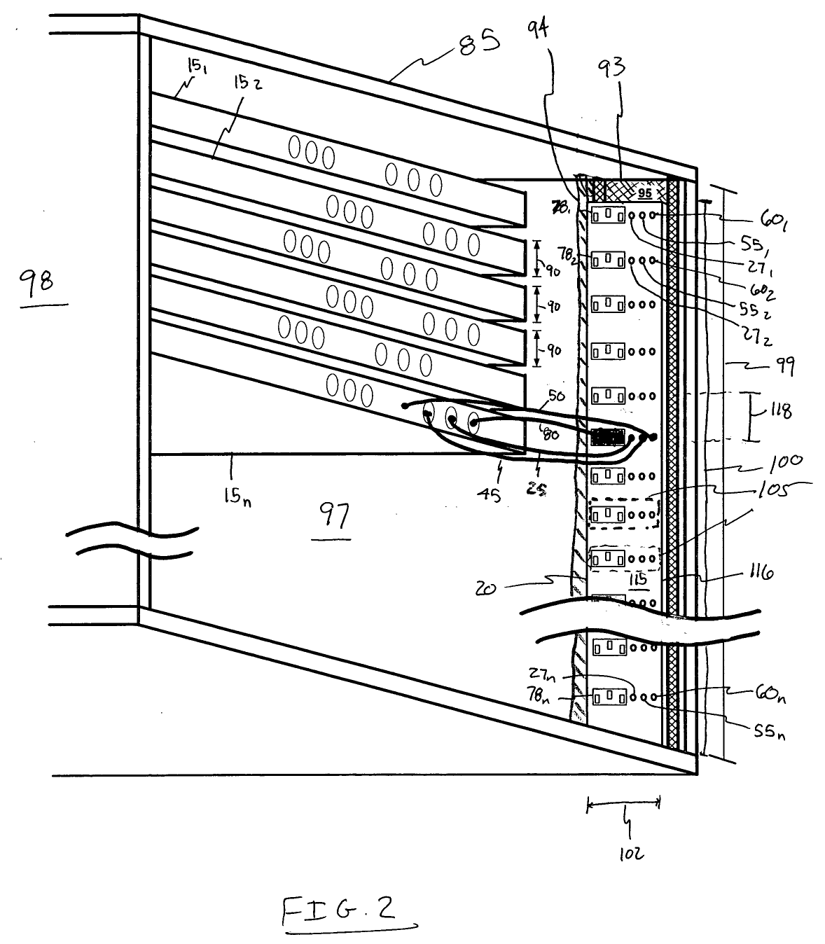

Referring also to FIG. 2, the network devices 15 are installed horizontally in a rack 85. The rack 85 is a standard equipment rack having multiple equipment positions 90 each of a standard height unit (i.e., a “U,” which is generally equal to 1.75″), such as a NetShelter® VX or SX Enclosure manufactured by APC Corporation of West Kingston, R.I. The rack 85 shown is exemplary, and other racks with different quantities and/or sizes of equipment positions 90 may be used.

The rack 85 includes side panels 97 and 98 and a plurality of brackets 93 forming recesses 95 (only one shown). The recesses 95 each have a height 99 substantially equal to an internal height 100 of the rack 85 and a width 102 of about 4.8 inches, although other recess sizes are acceptable. The brackets 93 are mounted to support posts 94 of the rack 85, although other configurations for mounting the bracket 93 are possible (e.g., mounting the brackets 93 to horizontal equipment support rails, or to the side panels 97, 98, etc.).

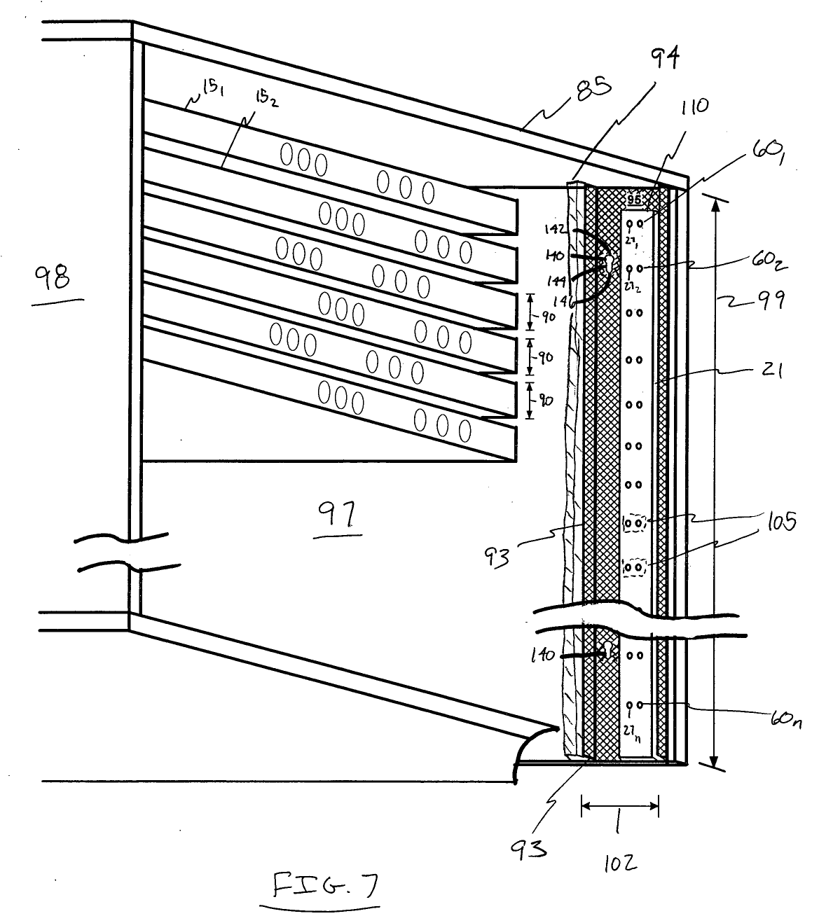

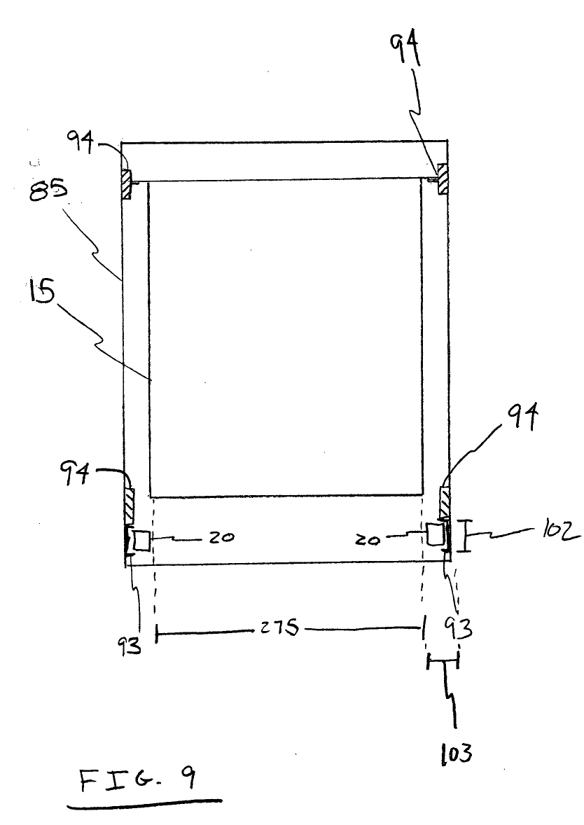

The management unit 20 is sized in conjunction with the recess 95 such that the management unit 20 occupies substantially all of the recess height 99 and substantially all of the recess width 102. A half-width management unit, e.g., a management unit 21 shown in FIG. 7, instead of a full-width management unit, such as the management unit 20, may be used. The half-width management units preferably occupy substantially all of the recess height and approximately half of the recess width 102. Thus, two half-width management units fit into the recess 95, side-by-side. A half-width embodiment will generally provide less than all four of the PDU, CPS, KVM, and network switch services. Referring also to FIG. 9, the depth of management unit 20 is preferably substantially equal to a depth of the recess 103 such that when installed in the recess 95, the management unit 20 does not extend into an air flow pathway 275, thereby reducing the cooling efficiency of the rack system 10. Other sizes of the depth 103 are possible, and it is further possible for the management unit 20 to extend into the air flow pathway 275. For example, the management unit 20 may be half as tall as the recess 95 allowing two of the network management units 20 to be installed, one above the other.

Referring to FIGS. 1 and 2 the management unit 20 contains one of the sets 105 for each of the rack positions 90 of the rack 85. Each of the sets 105 contains ports (connectors, receptacles, or attached cables) for each service provided by the management unit 20, and each of the sets 105 are substantially level with the middle of each of the rack positions 90 of the rack 85. Here, the sets 105 each have a KVM connector 60, a CPS connector 55, an Ethernet connector 27, and a power receptacle 78, though other combinations are possible (e.g., only a single CPS connector if the management unit 20 only provides CPS). Additionally, other functional combinations include: power, KVM, and Ethernet; power, CPS, and Ethernet; and/or KVM, CPS, and Ethernet. The sets 105 are disposed along the length of a front face 115 of a housing 116 of the management unit 20 with adjacent sets 105 having center-to-center spacing of approximately 1 U. Each of the sets 105 is configured such that when the management unit 20 is installed in the rack 85 there is a corresponding rack position 90 that is approximately horizontally aligned with each of the sets 105. The sets 105 may be disposed such that the connectors/receptacles/cables are disposed approximately in the middle of the height of the rack position 90 for a network device 15 to which the ports will be connected. Alternatively, the connectors/receptacles of the sets 105 may be disposed to be in substantial horizontal alignment with respective ports on the corresponding network devices 15 to which the connectors/receptacles/cables will be connected.

Other embodiments are possible. At least some alternative embodiments of the management unit 20 are configured such that each of the sets 105 is not approximately horizontally aligned with one of the rack positions 90 and/or include a number of sets 105 of ports not equal to the number of the equipment positions 90. For example, if the network devices 15 occupy two equipment positions 90 (i.e., are “2 U” devices), then the management unit 20 could have one set 105 for every two equipment positions 90. Further, some equipment in the rack may occupy 1 U while one or more other pieces of equipment occupy more than 1 U. The management unit 20 may be correspondingly configured so that the displacements of the sets 105 correspond to the heights of the corresponding equipment and thus the heights of the corresponding rack positions 90. The management unit 20 may omit the KVM connectors 60, the CPS connectors 55, the Ethernet connectors 27, and the power receptacle 78, instead using hardwired cables that connect to the network devices 15. The sets 105 may disposed on a face of the management unit 20 other than the front face 115 (e.g., a side or corner face). Each of the sets 105 may contain more than one connector for each service provided (e.g., two Ethernet connections, and/or two power connections).

Current printed circuit board (PCB) fabrication techniques limit PCBs to a few feet. Furthermore, the typical electrical interfaces on a PCB and between PCBs are limited to a few inches due to factors such as signal degradation. The network switch 40, the PDU 75, the CPS module 65, and the KVM switch 70 are adapted to use multiple PCBs while providing connectors/receptacles disposed along the length of the management unit 20, which can exceed the maximum manufacturable length of a single PCB.

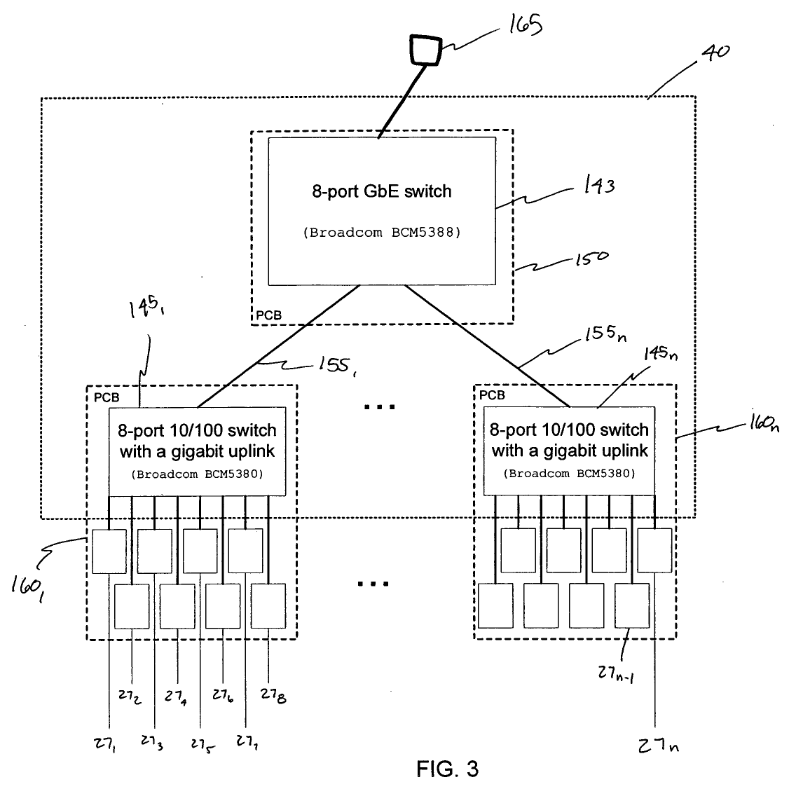

Referring to FIG. 3, the network switch 40 includes a primary PCB 150 and a plurality secondary PCBs 160 (although a single PCB 160 could be used in place of both the primary 150 and the secondary PCBs 160), with each PCB 150 and 160 sized less than or equal to the maximum manufacturable PCB size. Each of the secondary PCBs 160 are connected to the primary PCB 150 over a connection 155, which is a Gigabit Ethernet connection, although other speeds are possible. While FIG. 3 shows each secondary PCB 160 connected in parallel to the primary PCB 150, alternative network topologies may be used, such as connecting several of the secondary PCBs 160 in series with the primary PCB 150.

The primary PCB 150 includes a main Ethernet switch 143 and the secondary PCBs 160 each include an Ethernet switch 145. The Ethernet switch 143 and the Ethernet switches 145 are self-contained switches such that connections 155 can extend up to the height of the rack 85. Preferably, the Ethernet switch 143 is a Broadcom® BCM5388, and the Ethernet switches 145 are Broadcom® BCM5380, although other switches may be used. While each of the connections 155 utilize ports of the Ethernet switches 143 and 145, remaining unused ports may be connected to external connectors such as the Ethernet connectors 27, to supplemental Ethernet connectors 165, or multiple WAN up-links (e.g., the data network 35). Although a single Ethernet connector 165 is shown, other quantities are possible. A single PCB could function as both the primary and the secondary PCB. For example, if three 8-port Ethernet switches 145 and one 8-port main Ethernet switch 143 are used, then up to 29 external ports would be available for other connections (eight each from the switches 145, and five from the main switch 143). The five available ports of the main switch 143 may be connected to any of the Ethernet connectors 27.

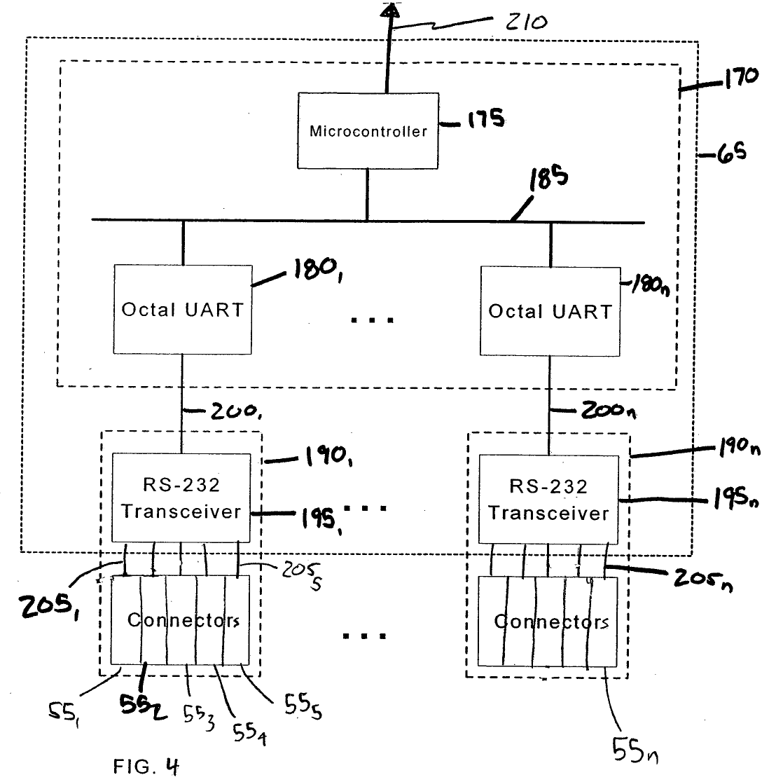

Referring to FIG. 4, the CPS module 65 includes a primary PCB 170 and a plurality of secondary PCBs 190, (although a single PCB could be used), with each PCB sized less than the maximum manufacturable PCB size. Each of the secondary PCBs 190 are connected to the primary PCB 170 by a point-to-point connection 200 (e.g., a ribbon cable, flex circuits, etc. While FIG. 4 shows each secondary PCB 190 connected to the primary PCB 170, alternative network topologies may be used such as bus connections (with the UARTs located on the secondary PCBs) to some or all of the secondary PCBs 190 (e.g., CAN, I²C). The CPS may provide an out-of-band method for managing the network devices 15 in the event that the Ethernet connection to an individual network device 15 has failed. (e.g., using CPS as an alternative method to manage the network device 15 in the case that the Ethernet connection to the network device 15 has been severed.

The primary PCB 170 contains a CPS microcontroller 175, an address data bus 185, multiple universal asynchronous receiver/transmitters (UARTs) 180, and a remote CPS connection 210 (typically internally connected to the Ethernet switch 40). The CPS microcontroller 175 is preferably a Motorola PowerPC MPC875ZT133. Different versions of the bus 185 are possible, such as a controller area network (CAN), a serial peripheral interconnect (SPI) bus, controller area network (CAN), an I²C bus, or USB. Under certain circumstances, using one of the alternative bus protocols for the bus 185, the UARTs 180 may be located on the secondary PCB 190. The bus 185 interconnects the CPS microcontroller 175 and the UARTs 180. The UARTs 180 are preferably Exar XR16L788CQ, but other components are possible. The PCBs 190 are disposed along substantially the entire length of the management unit 20.

The CPS microcontroller 175 is responsible for controlling the signal flow within, to, and from the CPS module 65, providing logic-level signals to the secondary CPS PCBs 190 via the UARTs 180, and is externally accessible to a network administrator via the remote CPS connection 210 routed via the network switch 40 (Referring also to FIG. 1, the remote CPS connection 210 may be connected to one or more other components within the management device 20). For example, the remote CPS connection 210 could be connected to a dedicated CPS port on the management unit 20, to the controller 44, to the external access device connection 43, or to the network switch 40. Each of these connections could be used by a network administrator to access the network devices 15 using a CPS connection via the management unit 20. While the CPS microcontroller 175 is shown as a separate component, the CPS controller 175 may be part of the controller 44 (FIG. 1). In this manner, several CPS sessions may be active at once, via the remote CPS connection 210.

Each of the secondary PCBs 190 contains a transceiver 195 that is connected to one of the connectors 55 via a line 205. The transceivers 195 are preferably a Sipex SP3238E or Sipex SP3243E, although other components may be used. While FIG. 4 shows a single transceiver 195 and a single connector 55 on each of the secondary PCBs 190, other quantities of the transceivers 195 and/or the connectors 55 per PCB are possible. Furthermore, while FIG. 4 shows the location of the connector 55 on the secondary PCB 190, the connector 55 may be located remotely from the PCB 190.

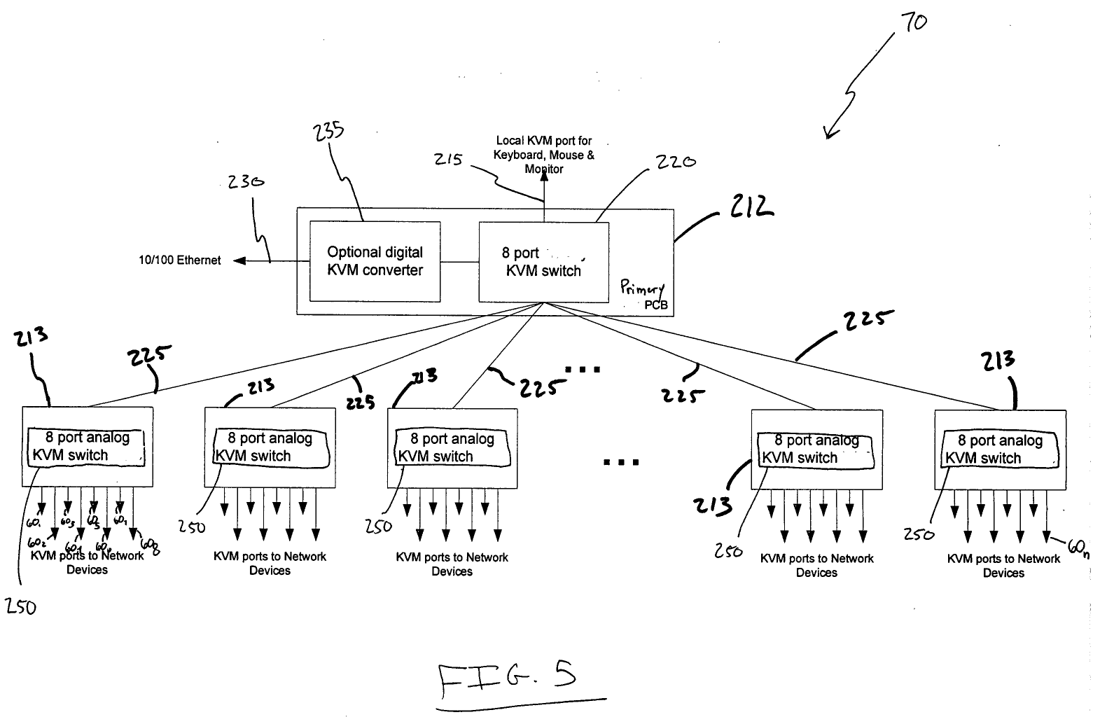

Referring to FIG. 5, the KVM switch 70 includes a primary PCB 212 and n secondary PCBs 213, with each PCB 212, 213 sized less than or equal to the maximum manufacturable PCB size. While five secondary PCBs 213 are shown, other quantities of secondary PCBs 213, including a single secondary PCB 213, may be used. The primary PCB 212 is connected to each of the secondary PCBs 213 for bi-directional communication via connections 225. The PCBs 213 are distributed along the length of the management unit 20 (FIGS. 1-2) to span a desired vertical extent of equipment positions (e.g., all of the equipment positions) in the rack 85 (FIG. 2) when the management unit 20 is mounted in the rack 85. The PCBs 213 may span substantially the entire length of management unit 20. The KVM switch 70 overcomes PCB manufacturing limitations to provide KVM switching over at least a portion of the length of the management unit 20 corresponding to the desired equipment positions in the rack 85.

The primary PCB 212 contains a primary KVM switch 220, and a digital KVM converter 235. The primary KVM switch 220 is functions as a bi-directional relay between a local connection 215 and each of the connections 225, relaying control signals (e.g., the signals to and from an individual keyboard, mouse and video screen) to and from the local connection 215 and secondary KVM switches 250 of the PCBs 213. The primary KVM switch 220 also acts as a bi-directional relay between the connections 225 and the digital KVM converter 235. The digital KVM converter 235 is configured to convert analog KVM signals to digital KVM signals (e.g., packetized Ethernet signals) and to depacketize digital KVM signals and convert them to analog signals, receiving/transmitting analog signals from/to the switch 220, and receiving/transmitting digitized signals from/to a connection 230. The KVM switch 70 receives the keyboard/video/mouse signals from the access device 42 via the digital KVM connection 230, which is preferably an Ethernet connector, although other connectors are possible. The digital KVM connection 230 may be a dedicated Ethernet connection on the management unit 20, or the digital KVM connection 230 may be internally connected to the network switch 40. Using the converter 235, a network operator may use Digital KVM over IP with the management unit 20. Using this arrangement, the network administrator has KVM access to the network devices 15 using an ordinary PC (running the appropriate KVM software) and an Ethernet connection.

The secondary PCB 213 contains the secondary KVM switches 250, and the KVM connectors 60, although the KVM connectors 60 may be disposed elsewhere. The KVM connectors 60 may be PCB or panel mounted and may be a single high-density connector, (e.g., a single RJ-45 that provides the keyboard, video, and mouse signals to/from each of the network devices 15), or traditional VGA+PS/2 connector, or other suitable connector. The secondary KVM switches 250 provide bi-directional communication between the primary PCB 212 (via the connections 225) and the network devices 15 selected by the network administrator. The KVM cable 50 may be a single Category-5 cable, a combination of VGA and PS/2 cables, or any other suitable cable(s). While FIG. 5 shows the primary PCB 212 and the secondary PCBs 213 as separate PCBs, a single PCB may be used.

Referring to FIG. 7, a half-width management unit 110 is shown. The half-width embodiment of the management unit 110 is preferably sized to allow two of the half-width management units 110 to fit side-by-side in the recess 95, although other sizes are possible. For example, a one-quarter width embodiment is possible.

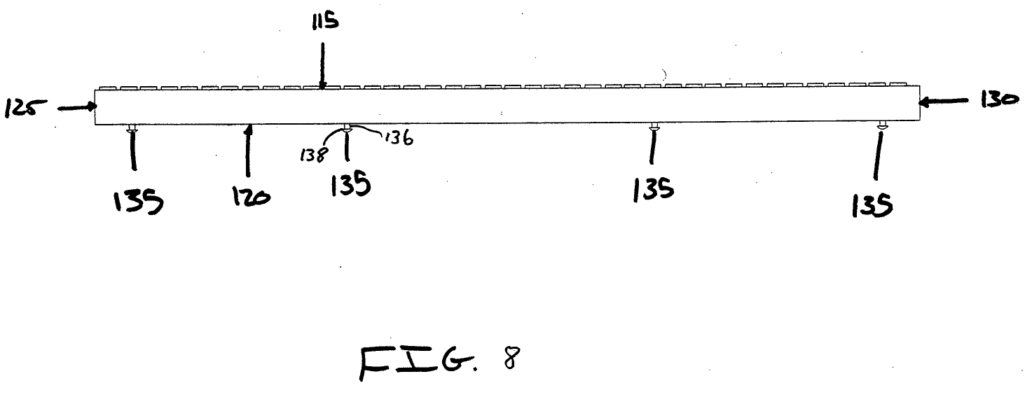

Referring to FIGS. 7-8, the management unit 20 (shown as half-width management unit 110 in FIG. 7) and the rack 85 are configured to provide toolless mounting of the management unit 20 in the rack 85. Posts 135 extend from a rear face 120 of the management unit 21. The posts 135 include a cylindrical shaft 136 and a flared end 138 of a larger diameter than the shaft 136. The posts 135 are configured in conjunction with keyhole-shaped openings 140 provided in the brackets 93 in the recess 95, although the openings 140 may be located elsewhere (e.g., the side panels 97 and 98). The brackets 93 may be disposed anywhere in the rack having sufficient space to allow installation of the management unit 20. For example, between the front of the equipment installed in the rack and the front of the rack, or multiple of the brackets 93 on one side of the rack between the rear of the equipment and the rear of the rack. The openings 140 can receive the flared ends 138 in circular portions 142 of the openings 140 and can receive the shafts 136 in slot portions 144 of the openings 140. The slot portions 144 have bottoms 146 and have widths that are larger than the diameters of the shafts 136 and that are smaller than the diameters of the flared ends 138. The management unit 20 may be mounted to the rack 85 by inserting the flared ends 138 of the posts 135 through the circular portions 142 and moving the management unit 21 downward such that the shafts 136 slide in the slots 144 until resting on one or more of the bottoms 146 of the slots 144. Notwithstanding the foregoing, other shapes/combinations may be used to accomplish toolless installation such as L-shaped protrusions combined with a slot, or the posts 135 may be square instead of cylindrical.

Numerous variations of the above description are possible. For example, the foregoing description refers to the network devices 15 as infrastructure devices or network-service devices. While such network devices have wide applicability, the network devices 15 can take other forms. For example, a network device 15 can be a printer, video tape recorder, digital video disc (“DVD”) player/recorder, audio equipment, video equipment, telephone equipment, electronic test equipment, etc. Further, while one switch is shown in FIG. 1, other quantities of switches may be used. Although an Ethernet switching configuration is shown in FIG. 1, other protocols may be used, such as Fibre Channel, Infiniband, asynchronous transfer mode (ATM), or SONET. Furthermore, while the network switch 40 is shown, an Ethernet hub or router could be used.

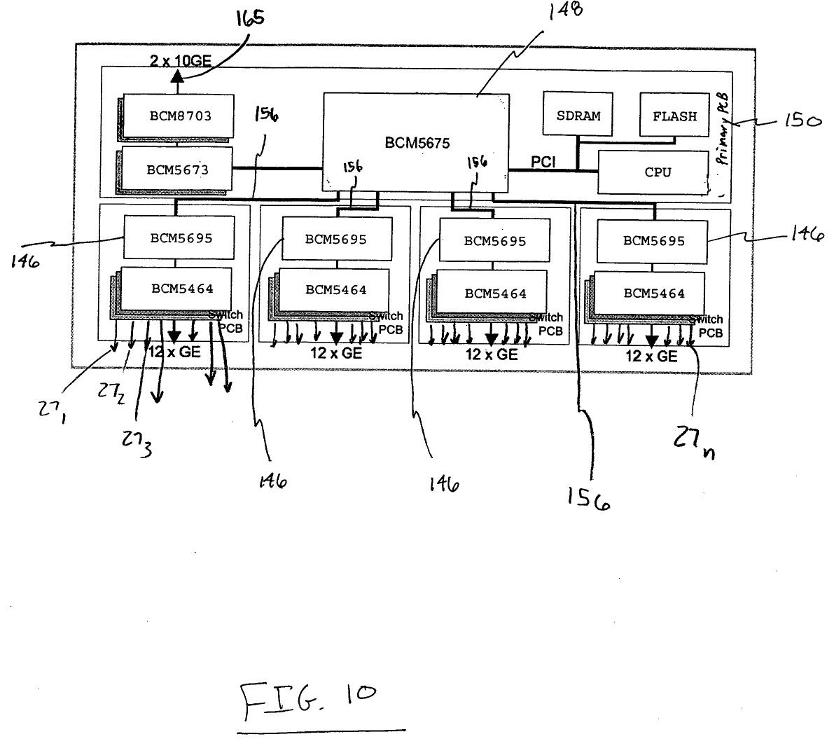

Also, other embodiments of network switches may be used. For example, referring to FIG. 10, a network switch 310 includes a primary PCB 312 and secondary PCBs 314. The primary PCB 312 includes a primary Ethernet switch 316, which is preferably a BCM5675 8-port 192-Gbps switched fabric made by Broadcom® Corporation of Irvine, Calif., although other switches are possible. The secondary PCBs 314 each contain a secondary Ethernet switch 318, which is preferably a BCM5695 Multi-layer 12-port Gigabit Ethernet stackable switch made by Broadcom®, although other switches are possible. Connections 320 interconnect the secondary Ethernet switches 318 to the primary Ethernet switch 316. The connections 320 are preferably XAUI interfaces, allowing the switches 318 to be located up to 44 inches away from the primary Ethernet switch 316, although other protocols and/or distances are possible.

Still other embodiments of network switches are possible. While FIG. 3 shows 8-port Ethernet switches, other configurations may be used, such as 16-port switches. The primary PCB may contain all of the Ethernet switches. The Ethernet switches can have various configurations, e.g., with speeds of 10 Mbps, 100 Mbps, and/or 1000 Mbps (or other speed), managed or unmanaged, with or without one or more high-speed uplinks, with or without VLAN support, with or without QoS support, etc. While the Ethernet protocol has been noted, the management unit 20 may also use other network protocols such as Fibre Channel, Infiniband, ATM, and/or SONET.

Various quantities of ports of each service type are possible per U, but preferably, devices provide one port of each service type per U of available rack space (e.g., an exemplary device for a 42 U cabinet has 42 Ethernet ports, 42 console port server ports, 42 KVM ports, and 42 AC outlets distributed over the length of the device). The Ethernet switch could use a modular connector such as an RJ-45 and Category-5 cables. These connectors may be PCB or panel mounted. The console port server could use a traditional DB9 connector (male or female; DTE or DCE) or a modular connector such as an RJ-11 or RJ-45. These connectors may be PCB or panel mounted. The KVM switch could use a single high-density connector, Category-5, or traditional VGA+PS/2 connector for each server. These connectors may be PCB or panel mounted. The KVM switch could also be SUN and USB compatible. Power distribution units could be un-metered, metered (e.g., having voltage, current, and power metered), or metered plus switched. Power distribution units preferably provide different input and output connections, branch circuit quantities, amperages, voltages, and phases. These features and combinations of features are exemplary, and not limiting of the invention.

Further, while the PDU 75, as described, distributes power, other functionality may be added. For example, the PDU 75 may have switching capabilities allowing a network administrator to remotely switch, (e.g., using the access device 42), individual power receptacles 78 (see FIG. 2) on or off. Embodiments of the PDU 75 may have voltage correction capability to ensure that a constant voltage is supplied to the network devices 15. The PDU may have metering capabilities to allow a network administrator to monitor electrical characteristics such as voltage, current, and power at the power source 22 and/or each of the power receptacles 78. Likewise, the PDU may also include other measurement capabilities such as a power factor, frequency, etc. The PDU 75 could provide different voltages, amperages, branch circuits, and single- or multi-phased power to the network devices 15. The PDU 75 could include surge and/or low-voltage protection.

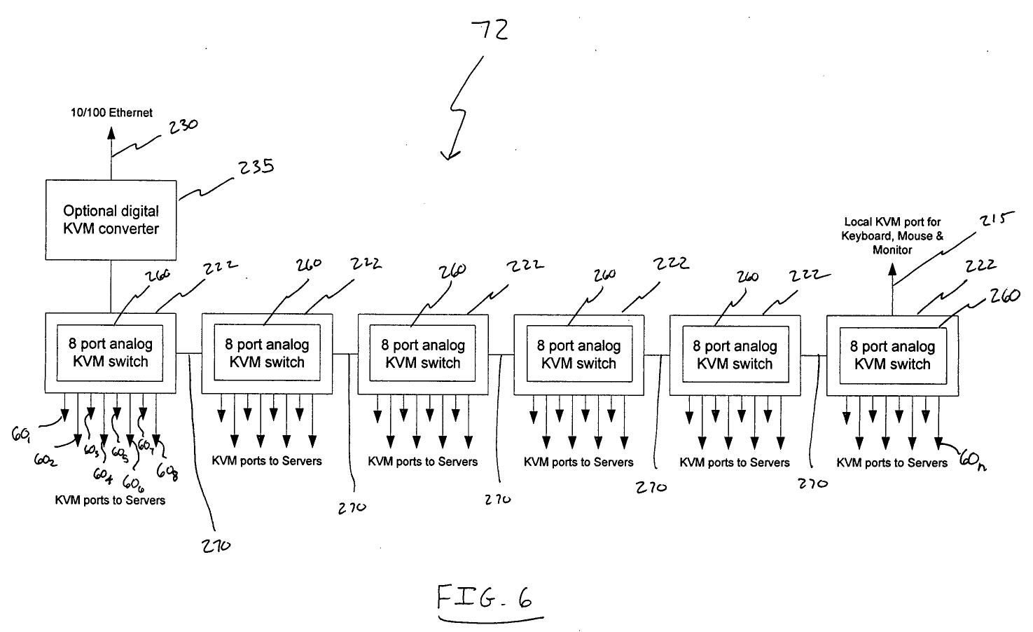

Further, other embodiments of KVM switches may be used. Referring to FIG. 6, a KVM switch 72 includes secondary PCBs 222 containing KVM switches 260. KVM connectors 60 are disposed on the secondary PCBs 222, although other locations are possible (e.g., the housing of the management unit 20). The KVM switches 260 are arranged connected in a daisy-chain configuration. Each of the KVM switches 260 are linked by a connection 270, and the KVM connectors 60 are disposed along at least a portion of the height of the management unit 20 corresponding to desired equipment positions in the rack 85 (FIG. 2), e.g., all of the equipment positions. Each of the KVM switches 260 receives all of the KVM signals, but disregards KVM signals addressed to a network device 15 connected to a KVM switch 260 other than itself. While FIG. 6 shows six of the KVM switch 260, each disposed on a separate secondary PCB 222, other quantities and/or configurations are possible (e.g., ten KVM switches 260, with two of the switches 260 disposed on each secondary PCB 222).

The KVM switch 72 includes the local KVM connection 215, the digital KVM connection 230, and the KVM signal converter 235. As with the switch 70 shown in FIG. 5, the converter 2235 is optional. The analog and digital connections (if present) are disposed at opposing ends of the daisy chain of the KVM switches 260, although other configurations are possible (e.g., both the local KVM connection 215 and the digital KVM connection 230 (including the KVM signal converter) may be connected to the same KVM switch 260).

Still other embodiments of KVM switches may be used. While the KVM switches 70 and 72, as shown, are configured to work with an external personal computer, or a keyboard, a video screen, and a mouse, other user control devices may be used. For example, the network administrator may use a touch screen, voice recognition, a joystick, a hand-held controller, or a mobile device (e.g., a cell phone or personal digital assistant (PDA)) to access the network devices 15 via the KVM switch 70. While the primary KVM switch 220 is shown as a separate unit, it may be combined with the controller 44. While the KVM switches 70 and 72 are shown with an analog and a digital (e.g., KVM over IP) connection, embodiments with only an analog or digital connection are possible. Furthermore, the local KVM connection 215 may be configured to accept digital video signals (not to be confused with “Digital KVM”) such as digital visual interface (DVI).

Embodiments of the management unit 20 include additional services and connectors such as environmental monitoring, physical status monitoring (e.g., monitoring door open status and possibly sounding an alarm when the rack door is open), analog inputs, analog outputs, contact inputs and contact outputs. The additional services may be configured to interface with the access device 42, the network devices 15, the controller 44, or the network switch 40.

While primary and secondary PCBs have been disclosed, the network switch 40, the CPS module 65, and/or the KVM switch module 70 may be disposed on a single PCB rather than a primary/secondary configuration, wherein the single circuit board contains all of the required components and a plurality of cables connect the outputs on the single PCB to the external connectors. Furthermore, while the controller 44 and the microcontroller 175 are disclosed as separate components, the functionality provided by both may be combined into a single component. Furthermore, the controller 44 may also provide control/communication for the network switch 40, and the KVM module 70.

While a U has been described as approximately 1.75″, other sizes are possible.

While the management unit has generally been described as containing a single connector for each service provided (e.g., 1 Ethernet connector, 1 power receptacle, 1 CPS connector, and 1 user control connector) per rack position, other combinations are possible. For example, multiple Ethernet or multiple power connections per rack position may be provided. A configuration having multiple connectors for each service provided for each rack position may be used, for example, with network devices requiring redundancy or extra capacity (e.g., two Ethernet links may be combined to create one “virtual” link with twice the bandwidth of a single link). Likewise, several of the management unit 20 may be used within a single rack for redundancy.

Still other embodiments are within the scope and spirit of the disclosure. The disclosure is illustrative only, and changes may be made in detail, especially in matters of shape, size, arrangement of parts, and number of components, within the principles of the disclosure, to the full extent indicated by the terms in which the claims are expressed. Furthermore, the scope of the invention is not to be limited by the specific examples

1. A network apparatus for use in an equipment rack configured to store equipment, in a plurality of vertically displaced equipment positions, the apparatus comprising:
a housing configured to be mounted to the rack, wherein the housing extends vertically in the rack to vertically overlap with at least two equipment positions;
at least one network service device configured to provide at least one of power, console port server (CPS) service, Ethernet service, and user control switching; and
a plurality of network service interfaces connected to the at least one network service device and disposed in substantially horizontal alignment with a respective plurality of the vertically displaced equipment positions of the equipment rack.

2. The network apparatus of claim 1 wherein at least two of the plurality of network service interfaces are connected to the same network service device have a first center-to-center spacing of substantially an integer multiple of a U.

3. The network apparatus of claim 1 wherein the interfaces are disposed in a plurality of groups, wherein each of the groups contains at least one of the network service interfaces corresponding to each of the at least one network service device, the plurality of groups having a second center-to-center spacing of substantially a multiple of a rack-unit (U).

4. The network apparatus of claim 3 wherein a quantity of the groups is equal to a quantity of the respective equipment positions in the rack.

5. The network apparatus of claim 1 wherein the at least one network service device is an Ethernet switch.

6. The network apparatus of claim 1 wherein the at least one network service device is configured to provide power and CPS service.

7. The network apparatus of claim 1 wherein the at least one network service device is configured to provide power and Ethernet switching.

8. The network apparatus of claim 1 wherein the at least one network service device is configured to provide power and user control switching.

9. The network apparatus of claim 1 wherein the at least one network service device is configured to provide user control switching.

10. The network apparatus of claim 9 wherein the user control switching is configured to provide keyboard/video/mouse (KVM) switching.

11. The network apparatus of claim 1 wherein the housing is configured to toollessly mount to the rack.

12. The network apparatus of claim 11 wherein the housing further comprises a protrusion configured to be inserted into and slide within a keyhole-shaped opening provided by the rack and to resist removal from the opening without sliding the protrusion within the opening.

13. The network apparatus of claim 1 wherein the network apparatus occupies substantially an entire width of a recess provided by the rack between the equipment and an end wall of the rack.

14. The network apparatus of claim 1 wherein the housing is sized to fit between a side wall of the rack and a side of the equipment disposed in the equipment positions without substantially blocking an air flow between the equipment and an end wall of the rack.

15. The network apparatus of claim 1 wherein the network apparatus occupies substantially half of an entire width of a recess provided by the rack between the equipment installed in the rack, and an end of the rack.

16. The network apparatus of claim 1 wherein the network apparatus further comprises:
a primary and a secondary Ethernet printed circuit board;
a primary Ethernet switch chip disposed on the primary Ethernet printed circuit board;
a secondary Ethernet switch chip disposed on the secondary printed circuit board;
an Ethernet connector connected to the secondary Ethernet switch chip; and
a high-speed Ethernet connection between the primary Ethernet switch chip and the secondary Ethernet switch chip.

17. The network apparatus of claim 1 wherein the network apparatus further comprises:
a primary CPS printed circuit board;
a secondary CPS printed circuit board;
a microcontroller;
a universal asynchronous receiver-transmitter (UART);
a bus connected to the microcontroller and to the UART, wherein the microcontroller, the bus, and the UART are disposed on the primary CPS printed circuit board; and
a transceiver disposed on the secondary CPS printed circuit board, each of the transceivers being connected to the UART.

18. The network apparatus of claim 1 wherein the network apparatus further comprises:
a primary KVM printed circuit board;
a secondary KVM printed circuit board;
an external interface and a primary KVM switch chip disposed on the primary KVM printed circuit board; and
a secondary KVM switch chip disposed on the secondary KVM printed circuit board, wherein the secondary KVM switch chip is connected to the primary KVM switch chip.

19. The network apparatus of claim 1 wherein the network apparatus further comprises:
a primary KVM printed circuit board;
a secondary KVM printed circuit board;
an external interface disposed on the primary KVM printed circuit board; and
a KVM switch chip disposed on the secondary KVM printed circuit board, the KVM switch chip being connected to the external interface.

20. The network apparatus of claim 19 wherein the network apparatus further comprises a plurality of secondary KVM PCBs, each including a secondary KVM switch chip, wherein the plurality of secondary KVM switch chips are daisy-chain connected.

21. The network apparatus of claim 20 wherein the at least one external interface is connected to one end of the serial configuration of the KVM switch chips.

22. A Zero-U network apparatus for use in an equipment rack that provides a vertical recess, the apparatus comprising:
a housing configured to be mounted to the rack;
an Ethernet switch disposed on a first set of printed circuit boards;
a power distribution unit (PDU) disposed on a second set of printed circuit boards; and
a plurality of connector groups each including at least one Ethernet connector and at least one power receptacle, the at least one Ethernet connector being connected to the Ethernet switch, the at least one power receptacle being connected to the PDU.

23. The Zero-U network apparatus of claim 22 further comprising:
a console port server module disposed on a third set of printed circuit boards; and
a plurality of console port server connectors connected to the console port server module, each of the plurality of connector groups further comprising at least one of the plurality of console port server connectors.

24. The Zero-U network apparatus of claim 22 further comprising:
a keyboard/video/mouse (KVM) switch; and
a plurality of KVM interfaces connected to the KVM switch, each of the plurality of connector groups further comprising at least one of the plurality of KVM interfaces.

25. The Zero-U network apparatus of claim 22 wherein the groups are disposed over a height greater than 24 inches.

26. The Zero-U network apparatus of claim 22 wherein the groups are disposed with a center-to-center spacing of about an integer multiple of a rack unit (U) apart.

27. The Zero-U network apparatus of claim 22 wherein the plurality of connector groups are substantially horizontally aligned with an equipment position in the equipment rack.

28. The Zero-U network apparatus of claim 27 wherein each of the at least one Ethernet connector is substantially horizontally aligned with a corresponding Ethernet connection on a piece of equipment installed in the rack.

29. The Zero-U network apparatus of claim 27 wherein each of the at least one power receptacle is substantially horizontally aligned with a corresponding power connection on a piece of equipment installed in the rack.

30. The Zero-U network apparatus of claim 22 wherein each of the plurality of groups is substantially horizontally aligned with a corresponding rack position.

31. The Zero-U network apparatus of claim 22 further comprising at least one of a console port server device, a user control switching device, an environmental monitoring device, and physical status monitoring device.

32. The Zero-U network apparatus of claim 22 wherein the Zero-U network apparatus extends substantially an entire internal height of the equipment rack.

33. The Zero-U network apparatus of claim 22 further comprising a plurality of protrusions disposed on a back of the housing, the protrusions adapted to be slidably received by a plurality of openings provided by the equipment rack, wherein the protrusions are configured to resist removal of the Zero-U network apparatus from the rack without sliding the protrusions within the openings, whereby the protrusions allow toolless mounting of the zero-U network apparatus in the equipment rack.

34. The Zero-U network apparatus of claim 33, wherein the protrusions are T-shaped.

35. The Zero-U network apparatus of claim 22, further comprising:
an adapter configured to be mounted to the rack; and
a plurality of protrusions disposed on a back of the housing, the protrusions adapted to be slidably received by a plurality of openings provided by at least one adapter bracket, the adapter bracket being disposed on a support beam of the equipment rack, wherein the protrusions are configured to resist removal of the Zero-U network apparatus from the adapter bracket without sliding the protrusions within the openings, whereby the protrusions allow toolless mounting of the zero-U network apparatus to the adapter in the equipment rack.

36. A network apparatus comprising:
an equipment rack having a plurality of vertically displaced equipment positions;
a housing configured to be mounted in the equipment rack, wherein the housing extends vertically in the rack to vertically overlap with at least two of the equipment positions;
at least one network service device configured to provide at least one of power, console port server (CPS) service, Ethernet service, and user control switching; and
a plurality of network service interfaces connected to the at least one network service device and disposed in substantially horizontal alignment with a respective plurality of the vertically displaced equipment positions of the equipment positions of the equipment rack.

37. The network apparatus of claim 36 wherein the interfaces are disposed in a plurality of groups, wherein each of the groups contains at least one of the network service interfaces corresponding to each of the at least one network service device, the plurality of groups having a second center-to-center spacing of substantially a multiple of a rack-unit (U).

38. The network apparatus of claim 36 wherein each of the groups is substantially horizontally aligned with one of the horizontal equipment positions.

39. The network apparatus of claim 36 wherein the housing is configured to toollessly mount to the rack.

40. The network apparatus of claim 36 wherein the housing provides a vertically-extending recess and the housing is configured to be disposed in the recess without substantially horizontally overlapping with equipment disposed in the equipment positions.
